(19) United States
(12) Patent Application Publication
(10) Pub. No.: US 2007/0137225 A1
(43) Pub. Date: Jun. 21, 2007

(54) AIR CONDITIONER HAVING UNPEOPLED MAINTENANCE FUNCTION

(75) Inventors: Akira Shindo, Ota-shi (JP); Keiji Nishida, Ota-shi (JP); Atsushi Niizato, Ashikaga-shi (JP); Masayuki Ishizeki, Ota-shi (JP); Masahiro Hiura, Ora-gun (JP); Yuichi Suzuki, Ota-shi (JP)

Correspondence Address: DARBY & DARBY P.C., P. O. BOX 5257, NEW YORK, NY, 10150-5257, US

(73) Assignee: Sanyo Electric Co., Ltd., Moriguchi-shi (JP)

(21) Appl. No.: 11/612,701

(22) Filed: Dec. 19, 2006

(30) Foreign Application Priority Data
Dec. 19, 2005 (JP) 2005-364365

(51) Int. Cl. G05D 23/12; F25B 13/00

(52) U.S. Cl. 62/160; 236/1 C

(57) ABSTRACT

An air conditioner that is equipped with an outdoor unit and an indoor unit and can perform cooling operation and heating operation including a remote controller for setting an upper limit value and a lower limit value for a desired room temperature, and a controller for controlling an unpeopled maintenance function of automatically carrying out cooling operation before the room temperature exceeds the upper limit value and also automatically carrying out heating operation before the room temperature underruns the lower limit value.

### BACKGROUND OF THE INVENTION

1. Field of the Invention

The present invention relates to an air conditioner that can keep the room temperature to a desired temperature.

2. Description of the Related Art

When the temperature of a room (room temperature) is set to a desired temperature value by an air conditioner, the air conditioner is required to be operated at all times. For example, in order to set the room temperature to 28° C. under cooling operation in summer season, the air conditioner is set to an operating state (thermo-ON state) to reduce the room temperature until the room temperature is equal to 28° C. or approximately equal to 28° C., and then set to an operation-stop state (thermo-OFF state) when the room temperature is further reduced to some lower limit temperature (slightly lower than 28° C.) Thereafter, when the room temperature increases and thus exceeds 28° C., the air conditioner is set to thermo-ON state again. This thermo ON/OFF operation of the air conditioner is repeated so that the room temperature is kept to 28° C. or approximately 28° C.

On the other hand, in order to set the room temperature to 20° C. under heating operation in winter season, the air conditioner is set to an operating state (thermo-ON state) to increase the indoor temperature until the room temperature is equal to 20° C. or approximately equal to 20° C., and then set to an operation-stop state (thermo-OFF state) when the room temperature is increased to some upper limit temperature (slightly higher than 20° C.). Thereafter, when the room temperature decreases and thus underruns 20° C., the air conditioner is set to thermo-ON state again. This thermo ON/OFF operation of the air conditioner is repeated so that the room temperature is kept to 20° C. or approximately 20° C. (see FIG. 6).

The above thermo-ON/OFF repetitive operation is an effective function to keep a comfortable work environment for persons working indoor. However, when the room is required to be kept to a certain range of room temperature after workers are out of a company or after they get away from the company to home, for example after workers are away from a computer room or the like, the above operation is excessively wasteful and consumes excessive power. On the other hand, if the operation of the air conditioner is stopped in the computer room, excessively temperature variation may occur or abnormality may occur in the operation of devices.

### SUMMARY OF THE INVENTION

The present invention has been implemented in view of the foregoing situation, and has an object to provide an air conditioner that can keep the room temperature in a predetermined range and save power.

In order to attain the above object, according to the present invention, an air conditioner that is equipped with an outdoor unit and an indoor unit and can perform cooling operation and heating operation include a setting unit for setting an upper limit value and a lower limit value for a desired room temperature, and an unpeopled maintenance function controlling unit for controlling an unpeopled maintenance function of automatically carrying out cooling operation before the room temperature exceeds the upper limit value and also automatically carrying out heating operation before the room temperature underruns the lower limit value.

According to the present invention, only when the room temperature approaches to the upper limit value or the lower limit value, the air conditioner is set to the thermo-ON state. Therefore, it is unnecessary to frequently repeat the thermo ON/OFF operation unlike the normal operation of the air conditioner.

In the above air conditioner, the setting unit may comprise a remote controller, and the unpeopled maintenance function may be set by the remote controller.

Accordingly, the user can easily set the unpeopled maintenance function (mode) by using the remote controller.

In the above air conditioner, the indoor unit may be provided with an indoor unit temperature sensor for detecting an indoor unit temperature and the remote controller may be provided with a temperature sensor for detecting a remote controller temperature, and any one of the indoor unit temperature and the remote controller temperature may be selected as the room temperature used for controlling the unpeopled maintenance function.

Accordingly, when any temperature difference occurs between the room temperature detected at the indoor unit side (indoor unit temperature) and the room temperature detected at the remote controller (remote controller temperature), the unpeopled maintenance function may be controlled by using any one convenient room temperature of the indoor unit temperature and the remote controller temperature.

Furthermore, in the above air conditioner, any one of the indoor unit temperature and the remote controller temperature may be selected so that the air conditioner can be more easily set to a thermo ON state.

Accordingly, in a case where any temperature difference occurs between the room temperature detected at the indoor unit side (indoor unit temperature) and the room temperature detected at the remote controller (remote controller temperature), the cooling (heating) operation may be carried out when any one of the indoor unit temperature and the remote controller temperature approaches to the upper limit value (lower limit value) of the desired room temperature.

In the above air conditioner, a cooling operation start temperature lower than the upper limit value and a cooling operation stop temperature lower than the cooling operation start temperature may be set in the unpeopled maintenance function, and the cooling operation may be started when the room temperature exceeds the cooling operation start temperature while the cooing operation is stopped when the room temperature underruns the cooling operation stop temperature.

In the above air conditioner, a heating operation start temperature higher than the lower limit value and a heating operation stop temperature higher than the heating operation start temperature may be set in the unpeopled maintenance function, and the heating operation may be started when the room temperature underruns the heating operation start temperature while the heating operation is stopped when the room temperature exceeds the cooling operation stop temperature.

According to the present invention, both the cooling operation and the heating operation can be performed. Therefore, the cooling operation is carried out before the room temperature exceeds the upper limit value, and the heating operation is carried out before the room temperature underruns the lower limit value, whereby the room temperature can be kept between the upper limit value and the lower limit value. Furthermore, the cooing operation and the heating operation are automatically switched to each other, so that the air conditioner does not carry out the thermo ON/OFF operation when the room temperature is between the upper and lower limit values. Therefore, power occurring due to repetitive thermo ON/OFF operation can be saved, and the power saving of the air conditioner can be performed.

Furthermore, the unpeopled maintenance function can be set by the remote controller, so that the user can easily set the unpeopled maintenance function. Accordingly, the convenience of the air conditioner can be enhanced.

Still furthermore, the indoor temperature used to control the unpeopled maintenance function may be set to any one of the indoor unit temperature and the remote controller temperature, whereby the convenience one of these temperatures can be used. Accordingly, for example when the remote controller temperature is selected as the room temperature used for the unpeopled maintenance function and the remote controller is put near by a computer, whereby the surrounding temperature of the computer can be detected with high precision and the surrounding temperature of the computer can be kept to a predetermined room temperature range.

Any one of the indoor unit temperature and the remote controller temperature which enables the air conditioner to be more easily set to the thermo ON state is selected as the room temperature for the unpeopled maintenance function. Therefore, the operation based on the unpeopled maintenance function is carried out when any one temperature approaches to the upper limit value or lower limit value of the desired room temperature, and thus even when any one of the detected temperatures is high, the control operation can be performed at the safer side.

### BRIEF DESCRIPTION OF THE DRAWINGS

FIG. 1 is a refrigerant circuit diagram showing an air conditioner according to an embodiment of the present invention;

FIG. 2 is a front view showing a remote controller display portion used for the air conditioner of the embodiment of the present invention;

FIG. 3 is a diagram showing the operation of an unpeopled (unmanned) maintenance function (mode) executed in the air conditioner according to the embodiment of the present invention;

FIG. 4 is a flowchart showing a method of controlling the operation based on the unpeopled maintenance function;

FIG. 5 is a flowchart showing a method of controlling the procedure of determining the room temperature when the unpeopled maintenance function is set; and

FIG. 6 is a schematic diagram showing the difference between the repetitive thermo ON/OFF operation around a desired fixed room temperature T (20° C.) under normal operation and the operation based on the unpeopled maintenance function when the room temperature is between T1 and T11.

### DETAILED DESCRIPTION OF THE PREFERRED EMBODIMENT

A preferred embodiment according to the present invention will be described hereunder with reference to the accompanying drawings.

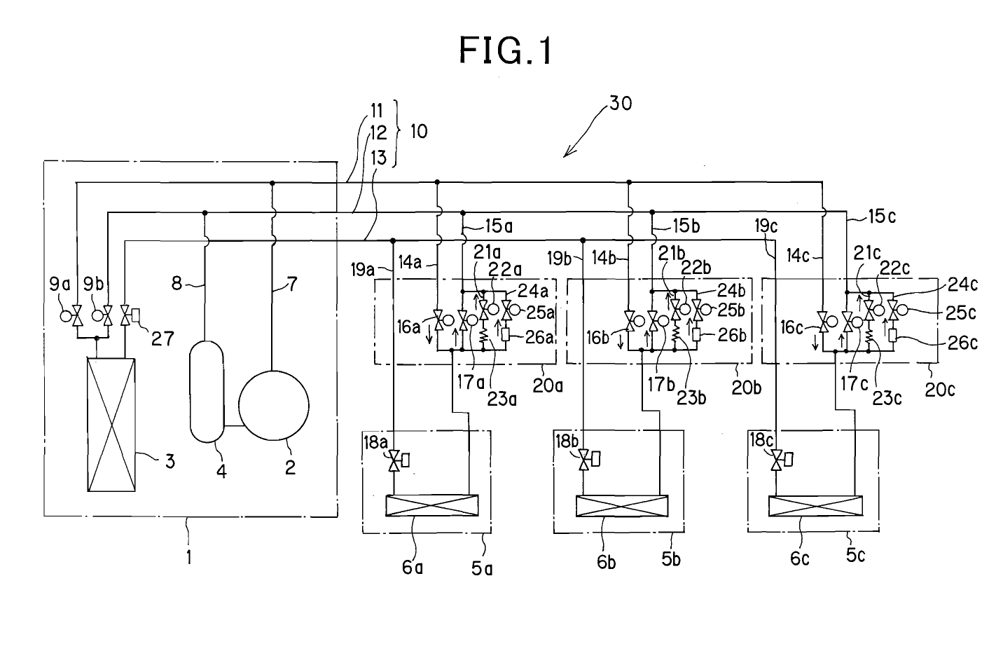

FIG. 1 is a refrigerant circuit diagram of an air conditioner according to the present invention.

An air conditioner 30 includes an outdoor unit 1 having a compressor 2, a water cooling type outdoor heat exchanger 3 and an outdoor expansion valve 27, an indoor unit 5a having an indoor heat exchanger 6a and an indoor expansion valve 18a, an indoor unit 5b having an indoor heat exchanger 6b and an indoor expansion valve 18b, and an indoor unit 5c having an indoor heat exchanger 6c and an indoor expansion valve 18c.

The outdoor unit 1 and the indoor units 5a, 5b and 5c are connected to one another through an inter-unit pipe 10. The air conditioner 30 can make the indoor units 5a, 5b and 5c carry out cooling operation or heating operation at the same time, and also make each of these indoor units 5a, 5b and 5c carry out any one of the cooling operation and the heating operation at the same time while the cooling and heating operations are mixed with each other.

In the outdoor unit 1, one end of the outdoor heat exchanger 3 is branched and selectively connected to the discharge pipe 7 and suction pipe 8 of the compressor 2 through change-over valves 9a and 9b, respectively. Furthermore, an accumulator 4 is disposed in the suction pipe 8.

The inter-unit pipe 10 is equipped with a high pressure gas pipe 11, a low pressure gas pipe 12 and a liquid pipe 13. The high pressure gas pipe 11 is connected to the discharge pipe 7, and the low pressure gas pipe 12 is connected to the suction pipe 8. The liquid pipe 13 is connected to the other end of the outdoor heat exchanger 3 through the outdoor expansion valve 27.

The other ends of the indoor heat exchangers 6a, 6b and 6c of the indoor units 5a, 5b and 5c are connected to the liquid pipe 13 through a liquid branch pipe 19a having the indoor expansion valve 18a disposed therein, a liquid branch pipe 19b having the indoor expansion valve 18b disposed therein and a liquid branch pipe 19c having the indoor expansion valve 18c disposed therein, respectively.

One end of the indoor heat exchanger 6a of the indoor unit 5a is connected to the high pressure gas pipe 11 through a high pressure gas branch pipe 14a, and also connected to the low pressure gas pipe 12 through a low pressure gas branch pipe 15a. One end of the indoor heat exchanger 6b of the indoor unit 5b is connected to the high pressure gas pipe 11 through a high pressure gas branch pipe 14b, and also connected to the low pressure gas pipe 12 through a low pressure gas branch pipe 15b. Furthermore, one end of the indoor heat exchanger 6c of the indoor unit 5c is connected to the high pressure gas pipe 11 through a high pressure gas branch pipe 14c, and also connected to the low pressure gas pipe 12 through a low pressure gas branch pipe 15c.

First opening/closing valves (first electromagnetic opening/closing valves) 16a, 16b and 16c are disposed in the high pressure gas branch pipes 14a, 14b and 14c, respectively. Furthermore, second opening/closing valves (second electromagnetic opening/closing valves) 17a, 17b and 17c are disposed in the low pressure gas branch pipes 15a, 15b and 15c, respectively.

A first bypass pipe 21a and a second bypass valve 24a are connected to the low pressure gas branch pipe 15a in parallel while bypassing the second opening/closing valve 17a. Furthermore, a first bypass pipe 21b and a second bypass valve 24b are connected to the low pressure gas branch pipe 15b in parallel while bypassing the second opening/closing valve 17b. Furthermore, A first bypass pipe 21c and a second bypass valve 24c are connected to the low pressure gas branch pipe 15c in parallel while bypassing the second opening/closing valve 17c.

Furthermore, a third opening/closing valve (third electromagnetic opening/closing valve) 22a and a capillary tube 23a are disposed in the first bypass pipe 21a, a third opening/closing valve (third electromagnetic opening/closing valve) 22b and a capillary tube 23b are disposed in the first bypass pipe 21b, and a third opening/closing valve (third electromagnetic opening/closing valve) 22c and a capillary tube 23c are disposed in the first bypass pipe 21c. A fourth opening/closing valve 25a and an orifice 26a are disposed in the second bypass pipe 24a, a fourth opening/closing valve 25b and an orifice 26b are disposed in the second bypass pipe 24b, and a fourth opening/closing valve 25c and an orifice 26c are disposed in the second bypass pipe 24c. In FIG. 1, reference numerals 20a, 20b and 20c represent electromagnetic valve kits.

Next, the driving operation will be described.

When all the indoor units 5a, 5b and 5c carry out cooling operation at the same time, the high pressure gas pipe 11 is set to a cease state. In this case, one change-over valve 9a of the outdoor heat exchanger 3 is opened while the other change-over valve 9b is closed, the first opening/closing valves 16a, 16b and 16c of the electromagnetic valve kits 20a, 20b and 20c are closed, and the second opening/closing valves 17a, 17b and 17c, the third opening/closing valves 22a, 22b and 22c and the fourth opening/closing valves 25a, 25b and 25c are opened. Accordingly, refrigerant discharged from the compressor 2 successively flows through the discharge pipe 7, the change-over valve 9a and the outdoor heat exchanger 3. The refrigerant is condensed and liquefied in the outdoor heat exchanger 3, passed through the liquid pipe 13 and the liquid branch pipes 19a, 19b and 19c and then distributed to the indoor expansion valves 18a, 18b and 18c of the respective indoor units 5a, 5b and 5c to be reduced in pressure. Thereafter, the refrigerant is evaporated and gasified in the respective indoor heat exchangers 6a, 6b and 6c, and then flows through the second opening/closing valves 17a, 17b and 17c, the third opening valves 22a, 22b and 22c and the fourth opening/closing valves 25a, 25b and 25c in parallel. Thereafter, the refrigerant is successively through the low pressure gas pipe 12, the suction pipe 8 and the accumulator 4, and then sucked into the compressor 2. As described above, all the indoor units 5a, 5b and 5c carry out the cooling operation at the same time by the respective indoor heat exchangers 6a, 6b and 6c acting as evaporators.

Furthermore, when all the indoor units 5a, 5b and 5c carry out heating operation at the same time, the low pressure gas pipe 12 is set to a cease state. In this case, one change-over valve 9a of the outdoor heat exchanger 3 is closed while the change-over valve 9b is opened, the first opening/closing valves 16a, 16b and 16c of the electromagnetic valve kits 20a, 20b and 20c are opened, and the second opening/closing valves 17a, 17b and 17c, the third opening/closing valves 22a, 22b and 22c and the fourth opening/closing valves 25a, 25b and 25c are closed. Accordingly, the refrigerant discharged from the compressor 2 is successively passed through the discharge pipe 7 and the high pressure gas pipe 11, and distributed to the high pressure gas branch pipes 14a, 14b and 14c. Thereafter, the refrigerant flows through the first opening/closing valves 16a, 16b and 16c and the indoor heat exchangers 6a, 6b and 6c and condensed and liquefied there, and then reduced in pressure in the respective indoor expansion valves 18a, 18b and 18c. Then, the refrigerant is passed through the liquid branch pipes 19a, 19b and 19c, and then flow together in the liquid pipe 13. Thereafter, the refrigerant is evaporated in the outdoor heat exchanger 3, successively passed through the change-over valve 9b, the suction pipe 8 and the accumulator 4 and then sucked into the compressor 2. All the indoor units 5a, 5b and 5c carry out heating operation at the same time by the respective indoor heat exchangers 6a, 6b and 6c acting as condensers as described above.

Furthermore, when the indoor units 5a and 5c carry out cooling operation and the indoor unit 5b carries out heating operation, all the refrigerant pipes 11, 12 and 13 are used. In this case, one change-over valve 9a of the outdoor heat exchanger 3 is opened while the other change-over valve 9b is closed, the first opening/closing valves 16a and 16c of the electromagnetic valve kits 20a and 20c of the indoor units 5a and 5c carrying out cooling operation are closed, and the second opening/closing valves 17a and 17c, the third opening/closing valves 22a and 22c and the fourth opening/closing valves 25a and 25c are opened while the second opening/closing valve 17b, the third opening/closing valve 22b and the fourth opening/closing valve 25b are closed. At this time, a part of the refrigerant discharged from the compressor 2 is successively passed through the discharge pipe 7 and the change-over valve 9a, and flows through the outdoor heat exchanger 3. The remaining refrigerant is passed through the high pressure gas pipe 11, and flows to the first opening/closing valve 16b and the indoor heat exchanger 6b of the electromagnetic valve kit 20b of the indoor unit 5b carrying out heating operation. The refrigerant is condensed and liquefied in the indoor heat exchanger 6b and the outdoor heat exchanger 3.

The refrigerant condensed and liquefied in the heat exchanger 6b and the outdoor heat exchanger 3 is passed through the liquid pipe 13, and reduced in pressure in the indoor expansion valves 18a and 18c of the indoor units 5a and 5c. Thereafter, the refrigerant is evaporated and gasified in the respective indoor heat exchangers 6a and 6c. Thereafter, the refrigerant flows through the second opening/closing valves 17a and 17c, the third opening/closing valves 22a, 22b and 22c and the fourth opening/closing valves 25a, 25b and 25c in parallel, and flow together in the low pressure gas pressure 12. The confluent refrigerant is successively passed through the suction pipe 8 and the accumulator, and then sucked into the compressor 2. As described above, the indoor unit 5b carries out heating operation by the indoor heat exchanger 6b acting as the condenser, and the indoor units 5a and 5c carry out cooling operation by the other indoor heat exchangers 6a and 6c acting as evaporators.

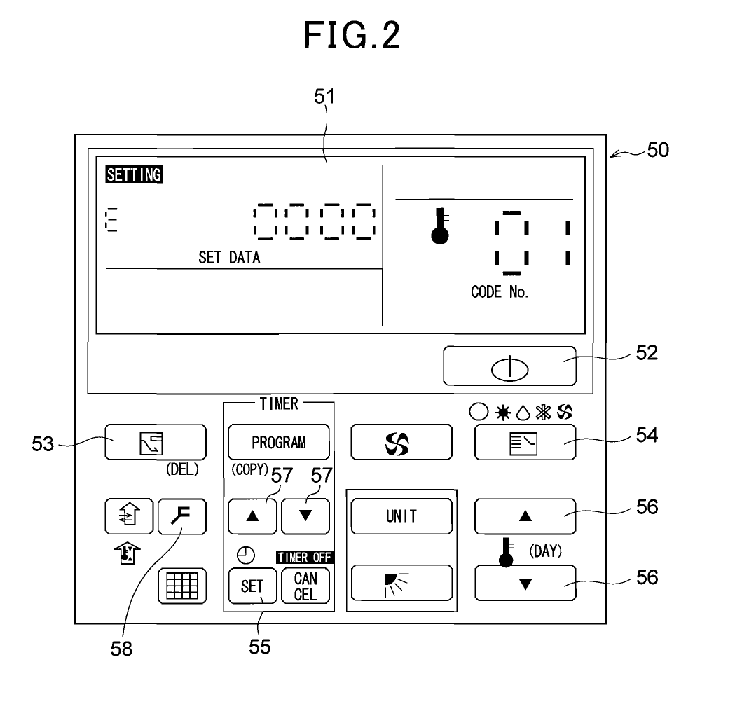

FIG. 2 is a diagram showing a remote controller display portion of the air conditioner according to the embodiment of the present invention. The air conditioner of this embodiment is equipped with an unpeopled (unmanned) maintenance function (mode). According to unpeopled maintenance function, a user sets the upper and lower limit values for a desired room temperature to the air conditioner 30. When the room temperature is about to exceed the upper limit value, the air conditioner is automatically set to carry out cooling operation, and when the room temperature is about to underrun the lower limit value, the air conditioner is automatically set to carry out heating operation. By operating a remote controller 50 or the like of the air conditioner 30, the ON/OFF operation of the unpeopled maintenance function and the upper and lower limit values of the room temperature can be set. The remote controller 50 may be connected to each indoor unit through a communication line or transmit signals wirelessly.

As shown in FIG. 2, the remote controller 50 includes a liquid crystal display portion 51 located at the upper portion thereof, a power supply button 52 located at the lower right side of the liquid crystal display portion 51 and various kinds of setting buttons located at the lower side of the power supply button 52. The various kinds of setting buttons mainly contain an unpeopled maintenance setting button 53 for setting ON/OFF of the unpeopled maintenance function, a mode switching button 54, a set button 55, a set temperature changing button 56, a set data switching button 57, a check button 58, etc. Furthermore, a temperature sensor (not shown) for detecting the room temperature is set to the remote controller 50.

When the unpeopled maintenance function is set by using the remote controller 50, it is carried out by pushing the unpeopled maintenance setting button 53. When the unpeopled maintenance function is set, a figure indicating that the unpeopled maintenance is set is displayed on the liquid crystal display portion 51. Furthermore, when the air conditioner 30 is operated under the unpeopled maintenance function, the above figure is displayed while the display flickers at an interval of one second. When the setting of the unpeopled maintenance function is released, the unpeopled maintenance setting button 53 is pushed again.

When the upper and lower limit values of the room temperature based on the unpeopled maintenance function are set by using the remote controller 50, the mode switching button 54 and the set button 55 are first continued to be simultaneously pushed for only 2 seconds under shutdown, thereby shifting to a setting screen. The upper limit value of the set temperature is displayed while flickering, and the upper or lower side of the setting temperature changing button 56 is pushed to select any set temperature. The upper limit value is set by pushing the set button 55. Thereafter, the lower limit value of the set temperature is displayed on the liquid crystal display portion 51 while flickering, and any set temperature is likewise selected/set.

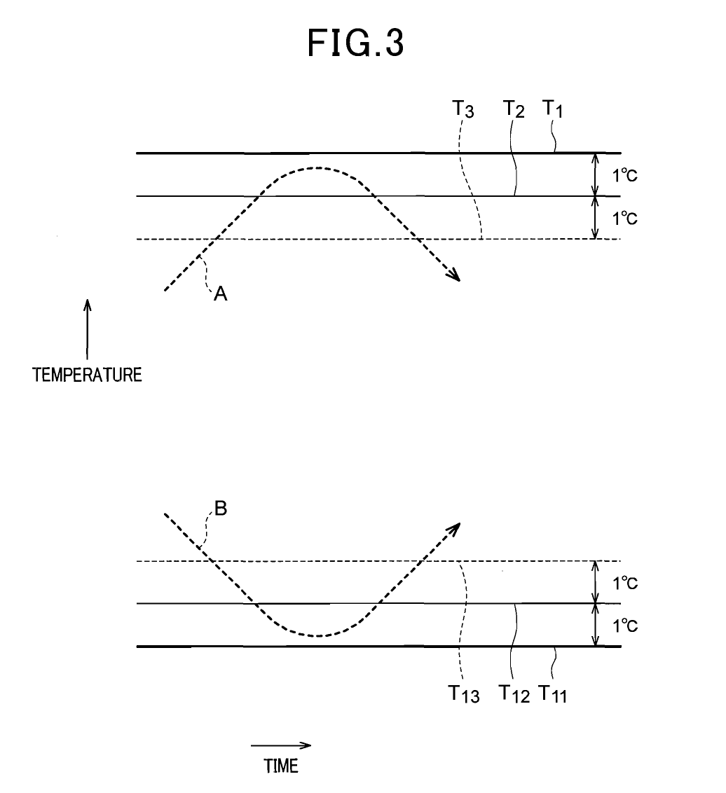

FIG. 3 is a diagram showing the unpeopled maintenance function. In FIG. 3, the room temperature is set in the vertical direction (up-and-down direction), and the lapse time is set in the horizontal direction (right-and-left direction). Furthermore, at the upper side of FIG. 3, the unpeopled maintenance upper limit temperature which is set with the remote controller or the like by the user is indicated by a horizontally extending line T1. Another horizontally extending line T2 represents a cooling operation start temperature which is set to be lower than the unpeopled maintenance upper limit temperature T1 by 1° C., and the other horizontally extending line T3 represents a cooling operation stop temperature which is set to be lower than the cooling operation start temperature T2 by 1° C.

Furthermore, at the lower side of FIG. 3, the unpeopled maintenance lower limit temperature which is set with the remote controller or the like by the user is indicated by a horizontally extending line T11. Another horizontally extending line T12 represents a heating operation start temperature which is set to be higher than the unpeopled maintenance lower limit temperature T1 by 1° C., and the other horizontally extending line T13 represents a heating operation stop temperature which is set to be higher than the heating operation start temperature T12 by 1° C.

Next, the relationship between the room temperature when the unpeopled maintenance function is set to ON and the operation of the air conditioner will be described with reference to FIG. 3.

(1) When the Room Temperature is Between the Unpeopled Maintenance Upper Limit Temperature T1 and the Unpeopled maintenance lower limit temperature T11

When the room temperature is between the temperature T1 and the temperature T11 under normal cooling operation, the air conditioner starts cooling operation so that the room temperature is approximate to the temperature T1. Furthermore, under normal heating operation, the air conditioner 30 starts heating operation until the room temperature is approximate to the temperature T11. On the other hand, under the state that the unpeopled maintenance function is set to ON, when the room temperature is between the temperature T1 and the temperature T11, neither cooling operation nor heating operation is carried out except for the following cases (2) and (3).

(2) When the Room Temperature is about to Exceed the Unpeopled Maintenance Upper Limit Temperature T1

In this case, the air conditioner 30 starts cooling operation at the temperature T2. Accordingly, the air conditioner 30 reduces the indoor temperature before the room temperature A reaches the temperature T1. Furthermore, when the room temperature A decreases to the temperature T3 under cooling operation, the cooling operation is stopped.

(3) When the Room Temperature is about to Underrun the Unpeopled Maintenance Lower Limit Temperature T11

In this case, the air conditioner 30 starts heating operation at the temperature T12. Accordingly, the air conditioner 30 increases the indoor temperature before the room temperature Breaches the temperature T11. Furthermore, when the room temperature B increases to the temperature T13 under heating operation, the heating operation is stopped.

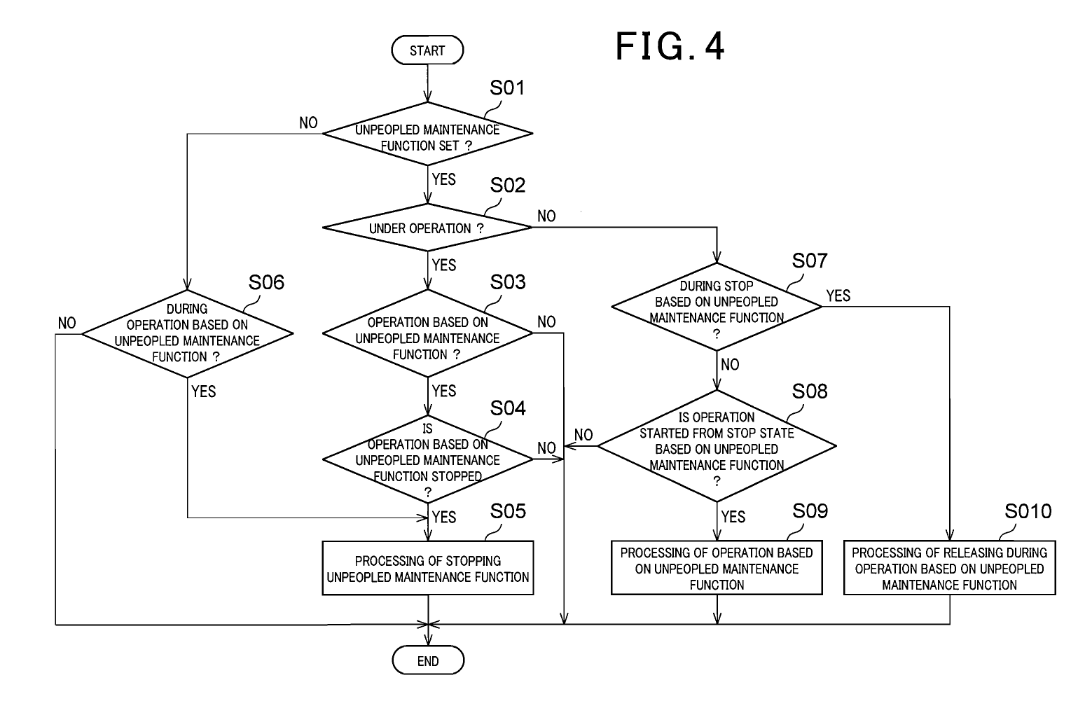

Next, a method of controlling the unpeopled maintenance function of the air conditioner according to this embodiment will be described with reference to FIG. 4. FIG. 4 is a flowchart showing the method of controlling the operation by using the unpeopled maintenance function.

In this control, it is first judged whether the unpeopled maintenance function is set by the remote controller 50 or the like (S01). If the unpeopled maintenance function is set, it is judged whether the air conditioner 30 is under operation (S02). When the air conditioner 30 is under operation, it is further judged whether the operation in S02 is based on the unpeopled maintenance function (S03). If the operation is based on the unpeopled maintenance function, a judgment of stopping the operation based on the unpeopled maintenance function is made (S04). This stop judgment is carried out by judging whether the room temperature is beyond the threshold value of the temperature T3 (T13). If the room temperature exceeds the threshold value, the processing of stopping the operation based on the unpeopled maintenance function is executed (S05), and the processing based on this control is finished. On the other hand, if the room temperature is not beyond the threshold value, the operation is continued and the processing based on the control is finished.

In the judgment of S01, for example, when the user releases the unpeopled maintenance function during the operation based on the unpeopled maintenance function, it is judged whether the operation based on the unpeopled maintenance function is carried out (S06). If the operation based on the unpeopled maintenance function is carried out, the processing of stopping the operation is immediately carried out (S05). On the other hand, if the operation based on the unpeopled maintenance function is not carried out, the processing of this control is finished.

If the air conditioner is not under operation in the judgment of S02, it is judged whether this stop state is set on the basis of the unpeopled maintenance function (S07). If this stop state is not set on the basis of the unpeopled maintenance function, it is judged whether the operation based on the unpeopled maintenance function should be carried out or not (S08). The judgment as to the execution of the operation based on the unpeopled maintenance function is made by judging whether the room temperature is beyond the threshold value of the temperature T2 (T12). If the room temperature is beyond the threshold value, the processing of executing the operation based on the unpeopled maintenance function is executed (S09), and the processing based on this control is finished. On the other hand, if the room temperature is not beyond the threshold value, the operation is continued, and the processing based on this control is finished. Furthermore, when the stop state is set on the basis of the unpeopled maintenance function in the judgment of S07, the processing of stopping the operation based on the unpeopled maintenance function is executed (S10), and the processing based on this control is finished.

Furthermore, when the operation is not based on the unpeopled maintenance function in the judgment of S03, the operation is continued, and the processing based on this control is finished.

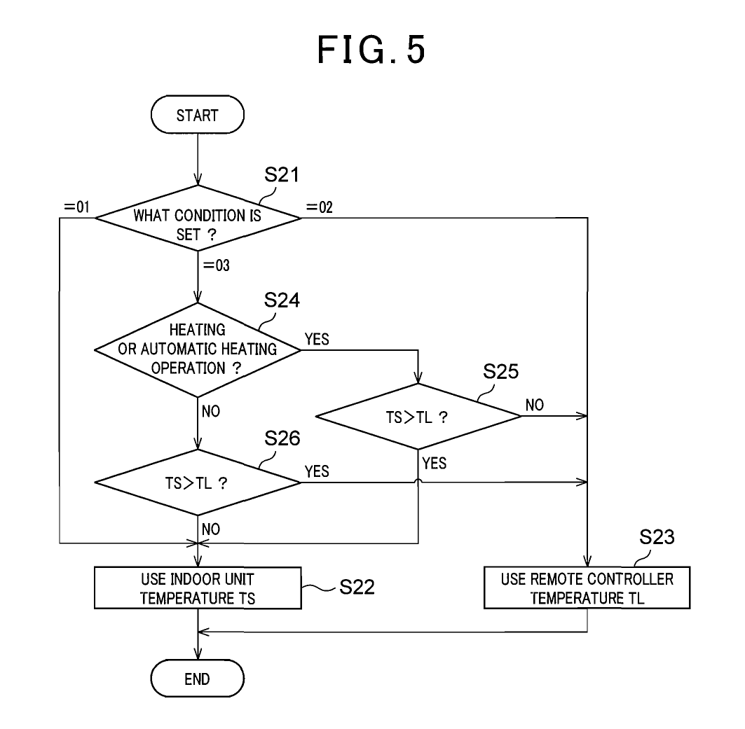

Next, a method of determining the room temperature when the unpeopled maintenance function is set will be described with reference to FIG. 5. FIG. 5 is a flowchart showing the procedure of determining the room temperature.

A remote controller temperature T detected by a temperature sensor provided to the remote controller 50 and an indoor unit temperature TS detected by a temperature sensor provided for controlling the indoor unit are utilized as the room temperature for the unpeopled maintenance function. The air conditioner 30 can select one of a case where the temperature Ts is sued (condition 01), a case where the temperature TL is used (condition 02) and a case where any one of the temperature TS and the temperature TL at which the air conditioner 30 is more easily set to thermo-ON is used (condition 00). As the factory default setting, the condition 00 is written in to a non-volatile memory for storing the set condition, and it is rewritable at all times.

Under this control, the set condition set in the non-volatile memory is first judged (S21). When the condition 01 using the temperature TS is written, the temperature TS is used without condition (S22). When the condition 02 using the temperature TL is written, the temperature TL is used without condition (S23). On the other hand, when the condition 03 is written, the operation mode when the unpeopled maintenance function is operated is judged (S24). If this operation mode is heating operation or automatic heating operation, it is judged whether the temperature TS is larger than the temperature TL (S25). If TS>TL, the indoor unit temperature TS is used (S22), and if not so, the remote control temperature TL is used (S23).

If in the judgment of S24 the operation mode is neither the heating operation nor the automatic heating operation, it is judged whether the temperature TS is larger than the temperature TL (S26) If TS>TL, the remote controller temperature TL is used (S23), and if not so, the indoor unit temperature TS is used (S22).

According to the air conditioner of this embodiment, the upper limit value T1 and the lower limit value T11 for a desired room temperature are set so that cooling operation is automatically carried out before the room temperature exceeds the upper limit value T1 and heating operation is automatically carried out before the room temperature under runs the lower limit value T11. That is, the air conditioner of this embodiment is provided with the unpeopled maintenance function. Therefore, the room temperature can be kept in the temperature range between the upper limit value and the lower limit value by carrying out cooling operation before the room temperature exceeds the upper limit value and carrying out heating operation before the room temperature underruns the lower limit value. Furthermore, by automatically switching cooling operation and heating operation to each other, the air conditioner does not carry out the thermo ON/OFF operation when the room temperature is between the upper limit value T1 and the lower limit value T11. Therefore, power consumed by the repetitive thermo-ON/OFF operation around a desired room temperature under normal operation can be saved by the unpeopled maintenance function of the air conditioner of this embodiment, and thus the power saving of the air conditioner can be performed.

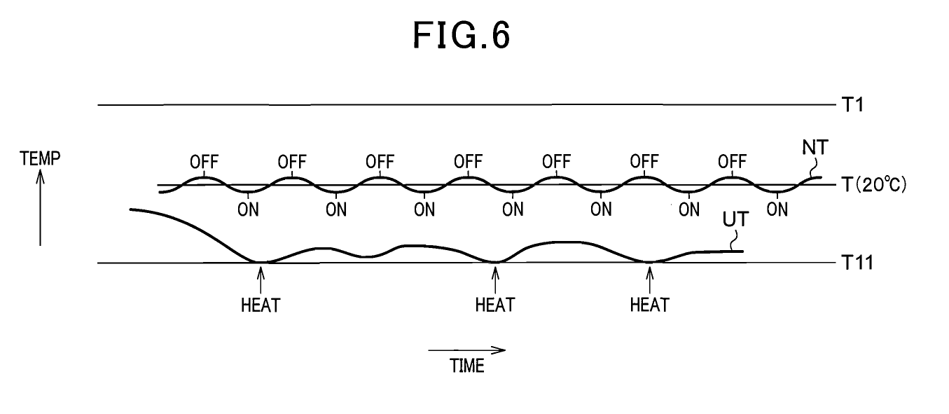

FIG. 6 is a schematic diagram showing the difference between the repetitive thermo ON/OFF operation around a desired fixed room temperature T (20° C.) under normal operation and the operation based on the unpeopled maintenance function when the room temperature is between T1 and T11. In FIG. 6, a curved line NT represents the normal thermo ON/OFF operation to keep the room temperature to T (for example, 20°) under heating operation, and a curved line UT represents the operation based on the unpeopled maintenance function to keep the room temperature in the range from T11 to T1 under a low temperature atmosphere according to the present invention.

As indicated by the curved line NT of FIG. 6, the normal thermo ON/OFF operation must be repetitively carried out at a higher frequency to keep the room temperature to the fixed temperature (20°) and thus it consumes a lot of power. On the other hand, as indicated by the curved line UT of FIG. 6, the repetitive frequency of the thermo ON/Off operation based on the unpeopled maintenance function is lower than the conventional thermo ON/OFF operation because no repetitive thermo ON/OFF operation is carried out when the room temperature is between T11 and T1. Accordingly, the power to be consumed by the air conditioner can be saved by the present invention. In FIG. 6, if the room temperature is not lower than the temperature T2, no heating operation is carried out even when the curved line UT approaches to the temperature T11. Such a portion is illustrated at the left side of the time chart of FIG. 6.

According to the present invention, the unpeopled maintenance function can be set by the remote controller 50, and thus the user can freely and easily switch the unpeopled maintenance function.

Furthermore, any one of the indoor unit temperature TS detected by the temperature sensor secured to the indoor unit and the remote controller temperature TL detected by the temperature sensor secured to the remote controller 50 may be selected as the room temperature used to control the unpeopled maintenance function. Therefore, the best room temperature optimum to various conditions can be used.

Still furthermore, any one of the indoor unit temperature TS and the remote controller temperature TL with which the air conditioner can be more easily set to the thermo ON state can be selected. Therefore, when any one room temperature approaches to the upper limit value T1 or the lower limit value T11 of the room temperature, the operation based on the unpeopled maintenance function is carried out. Therefore, even when one of the detected room temperatures is increased, the operation can be controlled to the safer side.

The present invention is not limited to the above-described embodiment, and various modifications and alterations may be made to the above embodiment on the basis of the technical idea of the present invention.

For example, in the above-described embodiment, the difference between the unpeopled maintenance upper limit value T1 and the cooling operation start temperature T2 is set to 1° C. However, for example when sharp variation of the room temperature is predicted, the difference between T1 and T2 may be set to 1° C. or more (for example, 2° C.). Furthermore, the temperature difference may be freely set to any value. Likewise, in the above embodiment, the difference between the unpeopled maintenance upper temperature T1 and the cooling operation stop temperature T3 is set to 2° C. However, it may be set to 2° C. or more, or it may be freely set to any value. Accordingly, the values of T2 and T3 can be adjusted in conformity with the predicted increase speed of the room temperature, and the control operation can be performed in conformity with the user environment.

Likewise, the temperature difference of the unpeopled maintenance lower limit temperature T11, the heating operation start temperature T12 and the heating operation stop temperature T13 can be freely set to any value.

What is claimed is:

1. An air conditioner that is equipped with an outdoor unit and an indoor unit and can perform cooling operation and heating operation, including:
a setting unit for setting an upper limit value and a lower limit value for a desired room temperature; and
an unpeopled maintenance function controlling unit for controlling an unpeopled maintenance function of automatically carrying out cooling operation before the room temperature exceeds the upper limit value and also automatically carrying out heating operation before the room temperature underruns the lower limit value.

2. The air conditioner according to claim 1, wherein the setting unit comprises a remote controller, and the unpeopled maintenance function can be set by the remote controller.

3. The air conditioner according to claim 2, wherein the indoor unit is provided with an indoor unit temperature sensor for detecting an indoor unit temperature and the remote controller is provided with a temperature sensor for detecting a remote controller temperature, and any one of the indoor unit temperature and the remote controller temperature is selected as the room temperature used for controlling the unpeopled maintenance function.

4. The air conditioner according to claim 3, wherein any one of the indoor unit temperature and the remote controller temperature is selected so that the air conditioner can be more easily set to a thermo ON state.

5. The air conditioner according to claim 1, wherein a cooling operation start temperature lower than the upper limit value and a cooling operation stop temperature lower than the cooling operation start temperature are set in the unpeopled maintenance function, and the cooling operation is started when the room temperature exceeds the cooling operation start temperature while the cooing operation is stopped when the room temperature underruns the cooling operation stop temperature.

6. The air conditioner according to claim 1, wherein a heating operation start temperature higher than the lower limit value and a heating operation stop temperature higher than the heating operation start temperature are set in the unpeopled maintenance function, and the heating operation is started when the room temperature underruns the heating operation start temperature while the heating operation is stopped when the room temperature exceeds the cooling operation stop temperature.
